(19) United States
(12) Patent Application Publication
(10) Pub. No.: US 2007/0228960 A1
(43) Pub. Date: Oct. 4, 2007

(54) PLASMA DISPLAY PANEL AND METHOD FOR MANUFACTURING THE SAME

(75) Inventor: Ji Hoon SOHN, Gyeonggi-do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/694,232

(22) Filed: Mar. 30, 2007

(30) Foreign Application Priority Data
Mar. 30, 2006 (KR) 10-2006-0028934

(51) Int. Cl. H01J 17/49

(52) U.S. Cl. 313/582

(57) ABSTRACT

A plasma display panel capable of achieving a reduction in the reflectance of the panel and a method for manufacturing the same are disclosed. The plasma display panel includes a lower substrate, a discharge cell space defined by a plurality of barrier ribs on the lower substrate, a phosphor layer formed in the discharge cell space, and a functional film formed over the phosphor layer.

This application claims the benefit of Korean Patent Application No. 10-2006-0028934, filed on Mar. 30, 2006, which is hereby incorporated by reference as if fully set forth herein.

### BACKGROUND OF THE INVENTION

1. Field of the Invention

The present invention relates to a plasma display panel, and more particularly to a plasma display panel capable of achieving a reduction in the reflectance of the panel and a method for manufacturing the same.

2. Discussion of the Related Art

Plasma display panels are well known as an emissive device which displays an image using a discharge phenomenon. Such a plasma display panel (PDP) is being highlighted as a display for an image display device having a large screen because the PDP has many advantages of simple manufacture, large screen size, and rapid response speed in that it is unnecessary to provide active elements for respective cells.

As shown in FIG. 1, such a PDP has a structure in which an upper panel 10 and a lower panel 20 are assembled such that they face each other. The upper panel 10 includes a transparent substrate 11, and a pair of sustaining electrodes 12 arranged on an inner surface of the transparent substrate 11. Typically, the sustaining electrodes 12 are divided into a transparent electrode and a bus electrode.

The sustaining electrodes 12 are coated with a dielectric layer 13 for AC driving. A protection film 14 is formed over the dielectric layer 13.

On the other hand, the lower panel 20 includes a lower substrate 21, and address electrodes 22 arranged on an inner surface of the lower substrate 21. A dielectric layer 23 is formed over the address electrodes 22. Stripe or well type barrier ribs 24 are formed on the dielectric layer 23, to isolate discharge cells from one another. Red, blue, green phosphor layers 26 for color display are coated over the cells defined by the barrier ribs 24, to form sub pixels.

The barrier ribs 24 define the discharge cells 25 for respective sub pixels. A discharge gas is sealed in each discharge cell 25. Three different sub pixels constitute one pixel.

However, the PDP has a structure in which the phosphor layers 26 exhibiting high reflectance are exposed to the eyes of the user through the transparent upper panel 10, as shown in FIG. 2. For this reason, external light may be reflected by the phosphor layers 26.

### SUMMARY OF THE INVENTION

Accordingly, the present invention is directed to a plasma display panel and a method for manufacturing the same that substantially obviate one or more problems due to limitations and disadvantages of the related art.

An object of the present invention is to provide a plasma display panel having an optical filter function such as an electromagnetic wave shield function or a color correction function, and a method for manufacturing the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a plasma display panel comprises: a lower substrate; a discharge cell space defined by a plurality of barrier ribs on the lower substrate; a phosphor layer formed in the discharge cell space; and a functional film formed over the phosphor layer.

In another aspect of the present invention, a plasma display panel comprises: an upper substrate; a dielectric layer covering sustaining electrodes formed on the upper substrate; and a functional layer arranged on the dielectric layer, the functional layer being made of MgO and a material having a refractive index different from MgO.

In another aspect of the present invention, a plasma display panel comprises: an upper substrate; a lower substrate; and an anti-reflection layer arranged between the upper substrate and the lower substrate, the anti-reflection layer comprising two or more layers having different refractive indexes.

In another aspect of the present invention, a method for manufacturing a plasma display panel comprises: forming a phosphor layer in a discharge cell space defined by a plurality of barrier ribs on a lower substrate; and forming an anti-reflection film over the phosphor layer.

In still another aspect of the present invention, a method for manufacturing a plasma display panel comprises: forming a dielectric layer covering sustaining electrodes formed on an upper substrate; and forming a functional layer over the dielectric layer, the functional layer comprising a first layer made of MgO and a second layer made of a material having a refractive index different from MgO.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view illustrating an example of a general plasma display panel;

FIG. 2 is a sectional view illustrating the general plasma display panel;

FIG. 3 is a sectional view illustrating a plasma display panel according an exemplary embodiment of the present invention; and

FIG. 4 is a sectional view illustrating a plasma display panel according to another embodiment of the present invention.

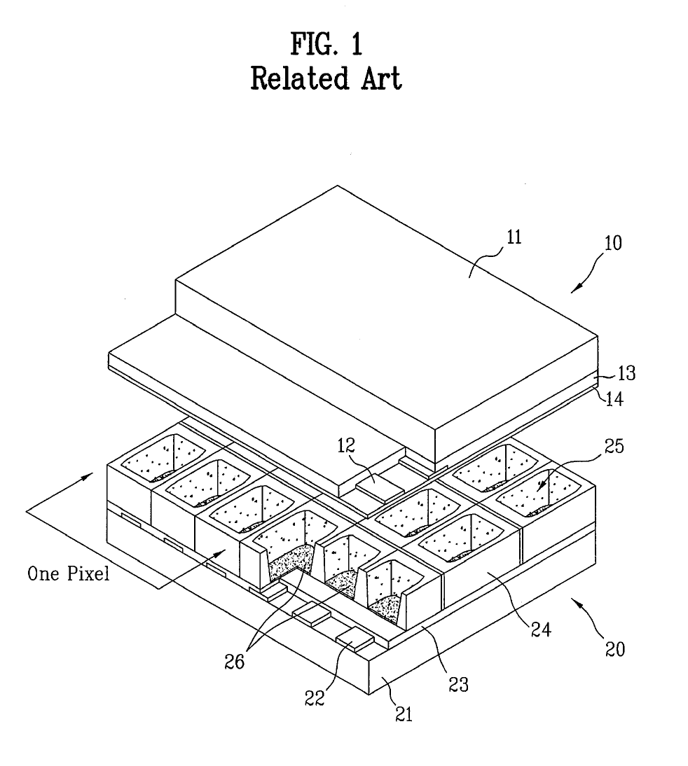

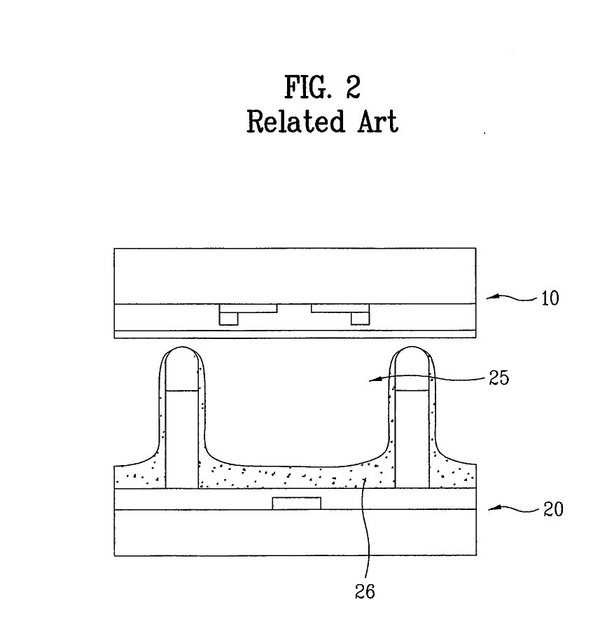

### DETAILED DESCRIPTION OF THE INVENTION

The present invention now will be described more fully hereinafter with reference to the accompanying figures, in which embodiments of the invention are shown.

This invention may, however, be embodied in many alternate forms and should not be construed as limited to the embodiments set forth herein. Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

Like numbers refer to like elements throughout the description of the figures. In the drawings, the thickness of layers and regions are exaggerated for clarity.

It will be understood that when an element such as a layer, region or substrate is referred to as being “on” another element, it can be directly on the other element or intervening elements may also be present. It will also be understood that if part of an element, such as a surface, is referred to as “inner,” it is farther to the outside of the device than other parts of the element.

In addition, relative terms, such as “beneath” and “overlies”, may be used herein to describe one layer's or region's relationship to another layer or region as illustrated in the figures.

It will be understood that these terms are intended to encompass different orientations of the device in addition to the orientation depicted in the figures. Finally, the term “directly” means that there are no intervening elements. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms.

These terms are only used to distinguish one region, layer or section from another region, layer or section. Thus, a first region, layer or section discussed below could be termed a second region, layer or section, and similarly, a second region, layer or section may be termed a first region, layer or section without departing from the teachings of the present invention.

### First Embodiment

Referring to FIG. 3, a plasma display panel (PDP) according to an exemplary embodiment of the present invention is shown. As shown in FIG. 3, the PDP includes an upper panel 100, a lower panel 200, and a functional film 300 formed in a discharge cell space 260 defined between the upper panel 100 and the lower panel 200.

The upper panel 100 includes an upper substrate 110, a sustaining electrode pair 120 arranged on the upper substrate 110, and a first dielectric layer 130 covering the sustaining electrode pair 120. The upper panel 100 also includes a protection film 140.

On the other hand, the lower panel 200 includes a lower substrate 210, an address electrode 220 formed on the lower substrate 210, and a second dielectric layer 230 covering the address electrode 220.

The sustaining electrode pair 120 and address electrode 220 intersect each other. That is, the sustaining electrode pair 120 and address electrode 220 extend while forming an angle of 90° therebetween. However, in FIG. 3, the sustaining electrode pair 120 and address electrode 220 are illustrated as extending in the same direction, for the convenience of the illustration.

A plurality of barrier ribs 240 are formed on the second dielectric layer 230 of the lower panel 200, to define discharge cell spaces 260. Phosphor layers 250 are formed in the discharge cell spaces 260 defined by the barrier ribs 240.

A functional film 300 having an anti-reflection function is formed over the phosphor layer 250 formed in each discharge cell space 260.

The functional film 300 may have a single-layer structure or a multilayer structure. The functional film 300 may be formed of a material substantially having a refractive index of 1 to 3.

Where the functional film 300 has a multilayer structure, it may be formed by alternately laminating a first film 310 and a second film 320 having different refractive indexes, as shown in FIG. 3. FIG. 3 illustrates a multilayer structure in which the first film 310 and second film 320 are alternately laminated two times. Of course, an increased number of films may be laminated.

The structure of the functional film 300 formed in accordance with a repeated film lamination can shield reflection light generated from the phosphor layer 250 or in the inner structure of the PDP in accordance with a light multi-interference phenomenon.

It is preferred that the functional film 300 be made of a material having sufficiently-high band-gap energy because it should not absorb visible rays or ultraviolet rays generated in the discharge cell space 260. Accordingly, the material of the functional film 300 may be selected such that the band-gap energy thereof is higher than the energy corresponding to blue light.

Materials suitable for the first film 310 and second film 320 of the functional film 300 and the refractive index and transmission wavelength ranges of the materials are shown in the following Table 1.

TABLE 1

| | | |
|---|---|---|
| | | Transmission |
| Material | Refractive Index | Wavelength Range |

| | | | | |
|---|---|---|---|---|
| Al₂O₃ | 1.63 | 550 nm | 200–5,000 | nm |
| CeF₃ | 1.63 | 500 nm | 300–5,000 | nm |
| Na₃AlF₆ | 1.33 | 500 nm | 250–14,000 | nm |
| HfO₂ | 2.0 | 500 nm | 230–7,000 | nm |
| ITO | 2.0 | 500 nm | 400–800 | nm |
| CaF₂ | 1.35 | 550 nm | 150–12,000 | nm |
| MgF₂ | 1.38 | 550 nm | 130–7,000 | nm |
| MgO | 1.7 | 500 nm | 200–8,000 | nm |
| SiO₂ | 1.46 | 550 nm | 200–2,000 | nm |
| Ta₂O₅ | 2.1 | 500 nm | 400–7,000 | nm |
| TiO₂ | 2.3 | 500 nm | 400–12,000 | nm |
| ZrO₂ | 2.05 | 500 nm | 300–7,000 | nm |
| BaF₂ | 1.4 | 10,600 nm | 220–11,000 | nm |
| ZnS | 2.4 | 1,200 nm | 400–14,000 | nm |
| PbF₂ | 1.7 | 500 nm | 220–9,000 | nm |

As shown in Table 1, materials exhibiting a refractive index of 1 to 3 with respect to a wavelength band of about 500 nm can be used. Such materials may include various materials such as oxides, fluorides, and semiconductors including Al₂O₃, CeF₃, Na₃AlF₆. HfO₂, indium tin oxide (ITO), CaF₂, MgO, SiO₂, Ta₂O₅, TiO₂, ZrO₂, BaF₂, ZnS, and PbF₂.

When one material is selected for the first film 310, another material having a refractive index different from the material of the first film 310 may be selected for the second film 310.

Where the functional film 300 has a single-layer structure, it can perform a desired anti-reflection function and other desired functions. However, when the first film 310 and second film 320 having different refractive indexes are alternately formed such that the functional film 300 has a multilayer structure, light beams reflected from the multilayer structure due to the refractive index difference of the films in the multilayer structure generate offset interference. As a result, it is possible to reduce the phenomenon that light incident to the interior of the PDP through the upper panel 100 is externally reflected.

Thus, the functional film 300 performs a function for preventing external light from being reflected from the discharge cell space 260 formed with the highly-reflective phosphor layer 250 after being incident to the discharge cell space 260, and thus, preventing the contrast of the panel from being reduced.

The formation of the functional film 300 may be achieved using a sputtering process, which is a dry process, or a spin coating process, which is a wet process. Of course, other methods may be used.

The functional film 300 may be formed at any position between the upper panel 100 and the lower panel 200 because it can achieve a desired function as long as it is arranged over the phosphor layer 250 in the discharge cell space 260.

If necessary, the functional film 300 may be arranged in the upper panel 100 or on the upper panel 100.

### Second Embodiment

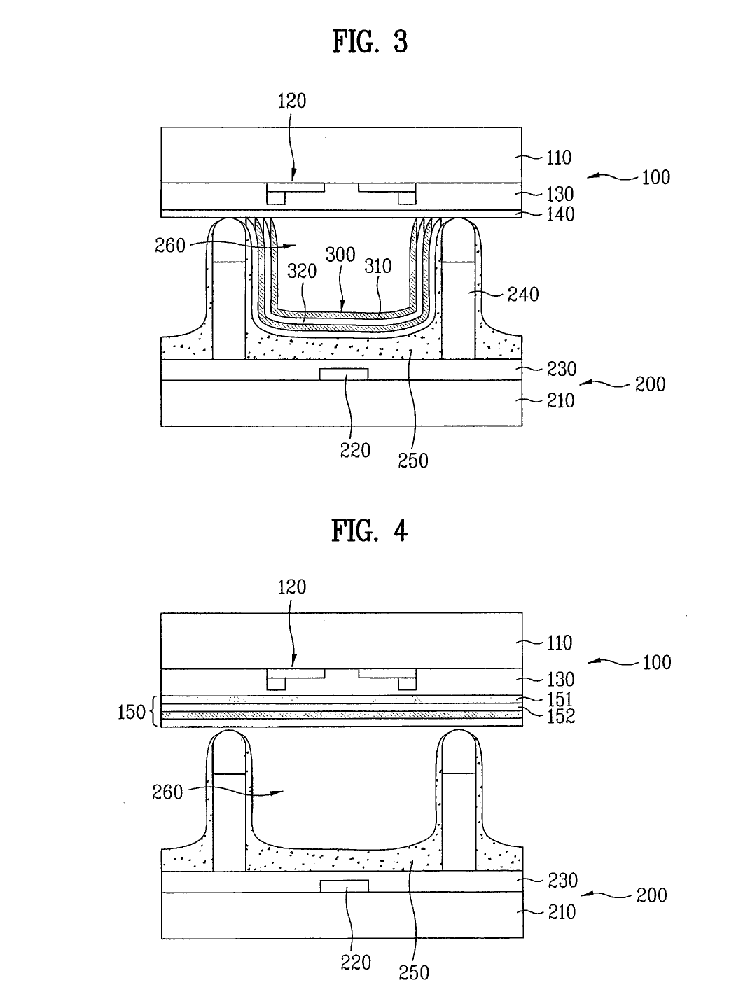

FIG. 4 illustrates a PDP having a structure in which a functional layer 150 is arranged on the lower surface of an upper panel 100.

In this structure, the upper panel 100 includes an upper substrate 110, and a first dielectric layer 130 covering sustaining electrode pairs 120 formed on an upper substrate 110. The functional layer 150 is arranged on the first dielectric layer 130. The functional layer 150 includes a layer made of MgO, and a layer made of a material having a refractive index different from MgO.

The functional layer 150 may have a multilayer structure including two or more layers. The functional layer 150 may have a protection film function for protecting the upper panel 100 from discharge occurring in the PDP, and an anti-reflection film function for preventing light incident to the PDP through the upper panel 100 from being reflected.

The functional layer 150 may include a first layer 151 made of MgO, and a second layer 152 made of a material other than MgO.

FIG. 4 illustrates a structure in which the first layer 151 of the functional layer 150 is formed over the first dielectric layer 130. Of course, the second layer 152 of the functional layer 150 may be formed over the first dielectric layer 150.

Although MgO is most generally used as the protection film of the PDP, a material other than MgO may also be used for the first layer 151.

The first layer 151 or second layer 152 may be selected from various materials such as oxides, fluorides, and semiconductors including Al₂O₃, CeF₃, Na₃AlF₆, HfO₂, indium tin oxide (ITO), CaF₂, SiO₂, MgO, Ta₂O₅, TiO₂, ZrO₂, BaF₂, ZnS, and PbF₂.

The formation of the functional film 150 may be achieved using a sputtering process, which is a dry process, or a spin coating process, which is a wet process. Of course, other methods may be used.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A plasma display panel comprising:
a lower substrate;
a discharge cell space defined by a plurality of barrier ribs on the lower substrate;
a phosphor layer formed in the discharge cell space; and
a functional film formed over the phosphor layer.

2. The plasma display panel according to claim 1, wherein the functional film comprises a single film having a refractive index of 1 to 3.

3. The plasma display panel according to claim 1, wherein the functional film comprises two or more films having different refractive indexes.

4. The plasma display panel according to claim 3, wherein the films of the functional film, which have different refractive indexes, are alternately arranged.

5. The plasma display panel according to claim 1, wherein the functional film is made of a material capable of transmitting ultraviolet rays generated in the panel.

6. The plasma display panel according to claim 1, wherein the functional film is made of at least one selected from Al₂O₃, CeF₃, Na₃AlF₆, HfO₂, indium tin oxide (ITO), CaF₂, MgO, SiO₂, Ta₂O₅, TiO₂, ZrO₂, BaF₂, ZnS, and PbF₂.

7. The plasma display panel according to claim 1, wherein the functional film is formed by alternately laminating a first film made of a material selected from Al₂O₃, CeF₃, Na₃AlF₆, HfO₂, indium tin oxide (ITO), CaF₂, MgO, SiO₂, Ta₂O₅, TiO₂, ZrO₂, BaF₂, ZnS, and PbF₂, and a second film made of a material other than the material of the first film, the material of the second film being selected from Al₂O₃, CeF₃, Na₃AlF₆. HfO₂, ITO, CaF₂, MgO, SiO₂, Ta₂O₅, TiO₂, ZrO₂, BaF₂, ZnS, and PbF₂.

8. A plasma display panel comprising:
an upper substrate;
a dielectric layer covering sustaining electrodes formed on the upper substrate; and
a functional layer arranged on the dielectric layer, the functional layer being made of MgO and a material having a refractive index different from MgO.

9. The plasma display panel according to claim 8, wherein the functional layer has a multilayer structure.

10. The plasma display panel according to claim 8, wherein the functional layer has a protection film function and an anti-reflection film function.

11. The plasma display panel according to claim 8, wherein the material, which has a refractive index different from MgO, can transmit visible rays or ultraviolet rays.

12. The plasma display panel according to claim 8, wherein the material, which has a refractive index different from MgO, is selected from Al₂O₃, CeF₃, Na₃AlF₆, HfO₂, indium tin oxide (ITO), CaF₂, SiO₂, Ta₂O₅, TiO₂, ZrO₂, BaF₂, ZnS, and PbF₂.

13. The plasma display panel according to claim 8, wherein the functional layer has a multilayer structure formed by alternately laminating a first layer made of MgO and a second layer made of the material which has a refractive index different from MgO.

14. A plasma display panel comprising:
an upper substrate;
a lower substrate; and
an anti-reflection layer arranged between the upper substrate and the lower substrate, the anti-reflection layer comprising two or more layers having different refractive indexes.

15. A method for manufacturing a plasma display panel, comprising:
forming a phosphor layer in a discharge cell space defined by a plurality of barrier ribs on a lower substrate; and
forming an anti-reflection film over the phosphor layer.

16. The method according to claim 15, wherein the anti-reflection film is made of at least one selected from Al₂O₃, CeF₃, Na₃AlF₆, HfO₂, indium tin oxide (ITO), CaF₂, SiO₂, MgO, Ta₂O₅/TiO₂, ZrO₂, BaF₂, ZnS, and PbF₂.

17. The method according to claim 15, wherein the anti-reflection film is formed by alternately laminating a first film made of a material selected from Al₂O₃, CeF₃, Na₃AlF₆, HfO₂, indium tin oxide (ITO), CaF₂, MgO, SiO₂, Ta₂O₅, TiO₂, ZrO₂, BaF₂, ZnS, and PbF₂, and a second film made of a material other than the material of the first film, the material of the second film being selected from Al₂O₃, CeF₃, Na₃AlF₆, HfO₂, ITO, CaF₂, MgO, SiO₂, Ta₂O₅, TiO₂, ZrO₂, BaF₂, ZnS, and PbF₂.

18. A method for manufacturing a plasma display panel, comprising:
forming a dielectric layer covering sustaining electrodes formed on an upper substrate; and
forming a functional layer over the dielectric layer, the functional layer comprising a first layer made of MgO and a second layer made of a material having a refractive index different from MgO.

19. The method according to claim 18, wherein the functional layer has a multilayer structure formed by alternately laminating the first layer and the second layer.

20. The method according to claim 18, wherein the material, which has a refractive index different from MgO, is selected from Al₂O₃, CeF₃, Na₃AlF₆, HfO₂, indium tin oxide (ITO), CaF₂, SiO₂, Ta₂O₅, TiO₂, ZrO₂, BaF₂, ZnS, and PbF₂.
